(19) United States
(12) Patent Application Publication
(10) Pub. No.: US 2012/0072338 A1
(43) Pub. Date: Mar. 22, 2012

(54) Machine, Program Product, and Computer-Implemented Method to Construct a Person-To-Person Loan

(76) Inventor: Trent Sorbe, Brookings, SD (US)

(21) Appl. No.: 13/232,700

(22) Filed: Sep. 14, 2011

Related U.S. Application Data
(63) Continuation of application No. 13/036,076, filed on Feb. 28, 2011.
(60) Provisional application No. 61/308,689, filed on Feb. 26, 2010.

(51) Int. Cl. G06Q 40/02

(52) U.S. Cl. 705/38

(57) ABSTRACT

Embodiments of the present invention provide a marketer for person-to-person lending or a bank server to promote a plurality of individual lenders bidding on a plurality of person-to-person loan requests from a plurality of individual borrowers to thereby construct person-to-person loans with a bank as an intermediary. The marketer computer establishes a person-to-person lending profile for the lender, include preferences for the lender. A bank server establishes an account for the benefit of the lender and determines an account balance for the individual lender. The bank server creates the loan with the borrower responsive to loan terms determined by the marketer computer. The bank server assigns at least part of the loan to the lender to construct the person-to-person loan with the bank as intermediary and withdraws funds corresponding to the at least part of the loan assigned to the lender from the account.

### 1. RELATED APPLICATIONS

This application is a continuation of and claims benefit and priority to U.S. patent application Ser. No. 13/036,076, filed on Feb. 28, 2011, titled “Machine, Program Product, and Computer-Implemented Method to Construct a Person-to-Person Loan,” which claims priority and the benefit to U.S. Provisional Patent Application No. 61/308,689, filed Feb. 26, 2010 titled “Machine, Program Product, and Computer-Implemented Method to Construct a Person-to-Person Loan,” that is incorporated herein by reference in its entirety.

### BACKGROUND OF THE INVENTION

2. Field of Invention

The present invention relates generally to the financial service and lending industries, and, more particularly, to machines, program products, and computer-implemented methods to construct a person-to-person loan transaction having a bank as an intermediary.

3. Description of the Related Art

Person-to-person lending, sometimes called “P2P” lending or alternately “peer-to-peer lending”, involves individual consumers making loans to other individual consumers. Increasingly prevalent, person-to-person lending enjoys significant, favorable publicity and positive feedback from United States bank regulators. Today, various person-to-person or peer-to-peer (“P2P”) lending websites have been developed and launched to provide access to loans, typically unsecured loans to individual consumers.

Perhaps negatively affecting the P2P lending marketplace, state regulations in many states, typically known as usury laws, limit lending interest rates. In addition, state regulation can impose licensing and other restrictions, limiting the P2P lending marketplace.

A large number of borrowers, however, do not get their loan requests fully funded. Borrower requests far exceed lender dollars available. Perhaps negatively affecting the P2P lending marketplace, prospective borrowers make loan requests without having an understanding of the quantity of funds available from prospective lenders and associated conditions, terms, or interest rates. For example, the pool of available P2P funds may be significantly increased for an interest rate over, e.g., thirty percent (30%), compared to the pool of available P2P funds for an interest rate below, e.g., thirty percent (30%). Thus, a borrower with a loan request indicating a maximum interest rate of, e.g., twenty-five percent (25%), may significantly reduce the likelihood that lenders will bid on the loan request. Similarly, the pool of available P2P funds for a borrower having at least a particular credit score or other indication of credit worthiness may be significantly increased compared to the pool of available P2P funds for a borrower not having at least the particular credit score or other indication of credit worthiness.

Because some P2P lending websites utilize group or affinity relationships, including relationships in FACEBOOK® or other social media websites, borrowers with no group or affinity relationship can have difficulty attracting individual lenders. Moreover, prospective borrowers make loan requests highlighting particular group or affinity relationships without having an understanding of the quantity of funds available from prospective lenders associated with those particular groups or affinity relationships, as well as any associated conditions, terms, or interest rates. For example, more prospective lenders or a larger pool of funds may be associated with a particular civic or fraternal organization than with a particular university or profession.

It is known that millions of prepaid cards are issued each year in the United States. It is also known that many of these cardholders rely primarily on cash and a prepaid card account for their personal finances; these cardholders may not have a traditional checking, savings, or other bank deposit account. Without a traditional checking, savings, or other bank deposit account, currently known P2P methods are unavailable or cost prohibitive to provide.

### SUMMARY OF INVENTION

In view of the foregoing, Applicant has recognized one or more sources of many of these problems and provides enhanced embodiments of machines, program products, and computer-implemented methods to construct a person-to-person loan transaction having a bank as an intermediary. For example, Applicant recognizes state laws and regulations as one or more sources of the problems affecting the person-to-person lending marketplace. Specifically, state licensing requirements add cost and restrict competition amongst lenders; moreover, state usury laws and restrictions on lending interest rates also limit the person-to-person lending marketplace. For example, Applicant recognizes a lack of information regarding lenders collectively, including preferences and amounts available to satisfy person-to-person loan requests, is a source of the problem.

Accordingly, Applicant provides example embodiments of technology, i.e., machines, program products and computer-implemented methods, that utilize a bank as an intermediary for person-to-person loan transactions. By having a bank serve as an intermediary, embodiments of bank servers, marketer computers, program products and computer-implemented methods provide compliance with, or avoid, state certain state regulations, such as licensing requirements. Furthermore, Applicants recognize that a federally-chartered bank is subject to federal banking laws and regulations so that state banking laws and regulations are preempted.

Applicant further provides example embodiments of a bank server maintaining lender funds in an account for the benefit of the lender. The aggregate funds on hand from the plurality of lenders can provide information, i.e., updated information, to the person-to-person lending marketplace, especially to borrowers and other prospective lenders through borrower computers and lender computers. The funds can augment a profile for the lender, with portions publically available through a marketer computer website as understood by those skilled in the art. Aggregating information for profiles of the plurality of lenders allows a marketer of person-to-person lending to promote specific amounts available for targeted borrowers. For example, a marketer through its website and marketer computer could suggest a certain amount of funds, e.g., $500,000, available to satisfy loan requests for members of a particular employees union or a certain amount of funds, e.g., $1,000,000, available to satisfy loan requests for recent military veterans. For example, a marketer computer and its website could, by contrast, identify relatively few funds available to satisfy loan requests for borrowers with extremely low credit scores seeking an interest rate below ten percent (10%). As understood by those skilled in the art, such preference information may be relevant and helpful to borrowers and their expectations in the person-to-person lending marketplace.

Example embodiments can include a computer-implemented method for causing a bank server, e.g., a computer associated with a bank defining a bank server, to perform a process of creating a loan from a bank to an individual borrower and a process of assigning at least part of the loan from the bank to an individual lender to construct a person-to-person loan between the individual lender and the individual borrower. The computer-implemented method can include establishing at the bank an account for the benefit of the individual lender. The account can be identified by an account number. The computer-implemented method can include determining for the account a balance associated with the individual lender defining a lenders balance. The lenders balance can (1) limit any bids from the lender responsive to a person-to-person loan request by the borrower (i.e., the lender can only bid on loans with funds on hand) and (2) augment a profile for the lender so that a marketer can promote to borrowers amounts of funds ready to lend, including any lender preferences. The computer-implemented method can include creating a loan from the bank to the borrower responsive to loan terms determined by the marketer computer and responsive to a bid from the lender. The computer-implemented method can include assigning at least part of the loan to the lender responsive to the creation of the loan from the bank to the borrower to construct the person-to-person loan transaction between the lender and borrower so that the bank serves as an intermediary. The computer-implemented method can include withdrawing funds corresponding to the at least part of the loan assigned to the lender from the account for the benefit of the lender.

Example embodiments can include a machine to perform a process of creating a loan from a bank to a borrower, i.e., an individual borrower, and a process of assigning at least part of the loan to a lender, i.e., an individual lender, to construct the person-to-person loan transaction between the lender and borrower so that the bank serves as an intermediary. The machine can include a first computer associated with the bank defining a bank server. The bank server can be adapted to or positioned to communicate with a second computer associated with a marketer for person-to-person lending defining a marketer computer. Through the marketer computer, a plurality of individual lenders can bid on a plurality of person-to-person loan requests from a plurality of individual borrowers. That is, the marketer computer can receive a plurality of person-to-person loan requests from a plurality of third computers, i.e., borrower computers, so that a plurality of fourth computers, i.e., lender computers, can transmit bids to the marketer computer, all computers communicating through an electronic communications network, e.g., the Internet, as will be understood by those skilled in the art. The plurality of borrow computers and the plurality of lender computers can be remote from the bank server, and the bank server has at least a processor and a tangible and non-transitory memory. The machine can include a computer program product operable on the bank server and stored in the tangible and non-transitory memory, as described herein.

Example embodiments can include a computer program product operable on the bank server and stored in the tangible and non-transitory memory. The computer program product includes a set of instructions that, when executed by the bank server, cause the bank server to perform various operations. The operations can include establishing at the bank an account for the benefit of the individual lender. The account can be identified by an account number. The operations can include determining for the account a balance associated with the individual lender defining a lenders balance. The lenders balance can (1) limit a bid from the lender responsive to a person-to-person loan request by the borrower and (2) augment a person-to-person lending profile for the lender. The person-to-person lending profile for the lender can include preferences for the lender. The operations can include creating a loan from the bank to the borrower responsive to loan terms determined by the marketer computer and responsive to the bid from the lender. For example, the bank server can load proceeds from the loan onto a prepaid card associated with the borrower. The operations can include assigning at least part of the loan to the lender responsive to the bid from the lender to construct the person-to-person loan between the lender and borrower so that the bank serves as an intermediary. The operations can further include withdrawing funds corresponding to the at least part of the loan assigned to the lender from the account for the benefit of the lender.

In addition, the operations can include assigning any remaining portion of the loan to one or more lenders of the plurality of lenders responsive to loan terms determined by the marketer computer and responsive to one or more bids from the one or more lenders of the plurality of lenders. That is, bids from multiple lenders can be aggregated to satisfy a single loan request from a borrower.

The operations can include generating, without further approval from the lender, a bid for the lender responsive to the person-to-person loan request by the borrower and responsive to the person-to-person lending profile for the lender. That is, a lender can automate the bid process according to the lender's preferences. Preferences for the lender can include, for example, a preferred interest rate; a preferred group relationship for the borrower requesting the loan; a preferred affinity relationship for the borrower requesting the loan; a preferred indication of credit worthiness for the borrower requesting the loan, such as a preferred credit score; and preferences for the lender declared by the lender and preferences for the lender determined responsive to actual bids on loan requests by the lender. For example, a lender may dedicate up to $200 a week to be loaned with an interest rate of fifteen percent (15%) or greater to borrowers with a credit score greater than, e.g., 650, and who are affiliated with the Boy Scouts of America. Responsive to these preferences and responsive to loan requests available on the marketer computer or bank server, the bank server can generate bids on behalf of the lender automatically.

Example embodiments include that the bank is federally-chartered bank subject to federal banking laws and regulations so that state banking laws and regulations are preempted. Embodiments of the present invention further include the bank as a first intermediary, assigning at least part of the loan to a second intermediary; the second intermediary then assigns the at least part of the loan to the lender. For example, the marketer can be a second intermediary. In addition, embodiments of the present invention include other machines, program products, systems, and associated methods to construct a person-to-person loan utilizing a bank as an intermediary, as will be understood by those skilled in the art.

### BRIEF DESCRIPTION OF DRAWINGS

So that the manner in which the features and benefits of the invention, as well as others which will become apparent, may be understood in more detail, a more particular description of the invention briefly summarized above may be had by reference to the embodiments thereof which are illustrated in the appended drawings, which form a part of this specification. It is also to be noted, however, that the drawings illustrate only various embodiments of the invention and are therefore not to be considered limiting of the invention's scope as it may include other effective embodiments as well.

FIG. 1 is a flow diagram of a bank as an intermediary for a person-to-person loan according to an embodiment of the present invention;

FIG. 2 is a flow diagram of a marketer constructing a person-to-person loan utilizing a bank as an intermediary according to an embodiment of the present invention;

FIG. 3 is a flow diagram of a marketer constructing a person-to-person loan utilizing a bank and the marketer as intermediaries according to an embodiment of the present invention;

FIG. 4 is a front plan view of a mobile phone device, including a display screen displaying a text message, according to an embodiment of the present invention;

FIG. 5 illustrates respective front and rear views of a prepaid card according to embodiments of the present invention;

FIG. 6 is a schematic block diagram of a point-of-sale hardware device according to an embodiment of the present invention;

FIG. 7 is a schematic block diagram of a system to constructing a person-to-person loan transaction according to an embodiment of the present invention;

FIG. 8 is a schematic block diagram illustrating an exemplary database construction for a system to construct a person-to-person loan transaction according to an embodiment of the present invention;

FIG. 9 is a schematic diagram of a computer server having program product stored in tangible and non-transitory memory thereof according to an embodiment of the present invention;

FIG. 10 is a schematic flow diagram of a computer-implemented method for causing a bank server to perform a process of creating a loan from a bank to a borrower and a process of assigning at least part of the loan to a lender to construct a person-to-person loan according to an embodiment of the present invention;

FIG. 11 is a front plan view of a display screen of a computer displaying lender profile configuration according to an embodiment of the present invention;

FIG. 12 is a schematic diagram of a computer server having program product comprising various modules stored in tangible and non-transitory memory thereof according to an embodiment of the present invention;

FIG. 13 is a schematic flow diagram of a computer-implemented method performed in conjunction with an account establishment module according to an embodiment of the present invention;

FIG. 14 is a schematic flow diagram of a computer-implemented method performed in conjunction with a balance determiner module according to an embodiment of the present invention;

FIG. 15 is a schematic flow diagram of a computer-implemented method performed by a bid generator according to an embodiment of the present invention;

FIG. 16 is a schematic flow diagram of a computer-implemented method performed by a loan management module on a bank server according to an embodiment of the present invention; and

FIG. 17 is a schematic flow diagram of a computer-implemented method performed in conjunction with a fund manager module on a bank server according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein; rather, these embodiments are provided so that this disclosure will be thorough and complete, and will fully convey the scope of the invention to those skilled in the art. Like numbers refer to like elements throughout.

Applicant has recognized one or more sources of many of the problems affecting the P2P lending marketplace . For example, Applicant recognizes state laws and regulations as one or more sources of the problems affecting the person-to-person lending marketplace. Specifically, state licensing requirements add cost and restrict competition amongst lenders; moreover, state usury laws and restrictions on lending interest rates also limit the person-to-person lending marketplace. For example, Applicant recognizes a lack of information regarding lenders collectively, including preferences and amounts available to satisfy person-to-person loan requests, is a source of the problem.

Accordingly, Applicant provides example embodiments of technology, i.e., machines, program products and computer-implemented methods, that utilize a bank as an intermediary for person-to-person loan transactions. By having a bank serve as an intermediary, embodiments of bank servers, marketer computers, program products and computer-implemented methods provide compliance with, or avoid, state certain state regulations, such as licensing requirements. Furthermore, Applicants recognize that a federally-chartered bank is subject to federal banking laws and regulations so that state banking laws and regulations are preempted.

Applicant further provides example embodiments of a bank server maintaining lender funds in an account for the benefit of the lender. The aggregate funds on hand from the plurality of lenders can provide information, i.e., updated information, to the person-to-person lending marketplace, especially to borrowers and other prospective lenders through borrower computers and lender computers. The funds can augment a profile for the lender, with portions publically available through a marketer computer website as understood by those skilled in the art. Aggregating information for profiles of the plurality of lenders allows a marketer of person-to-person lending to promote specific amounts available for targeted borrowers. For example, a marketer through its website and marketer computer could suggest a certain amount of funds, e.g., $500,000 available to satisfy loan requests for members of a particular employees union, or a certain amount of funds, e.g., $1,000,000, available to satisfy loan requests for recent military veterans. For example, a marketer computer and its website could, by contrast, identify relatively few funds available to satisfy loan requests for borrowers with extremely low credit scores seeking an interest rate below ten percent (10%). As understood by those skilled in the art, such preference information may be relevant and helpful to borrowers and their expectations in the person-to-person lending marketplace.

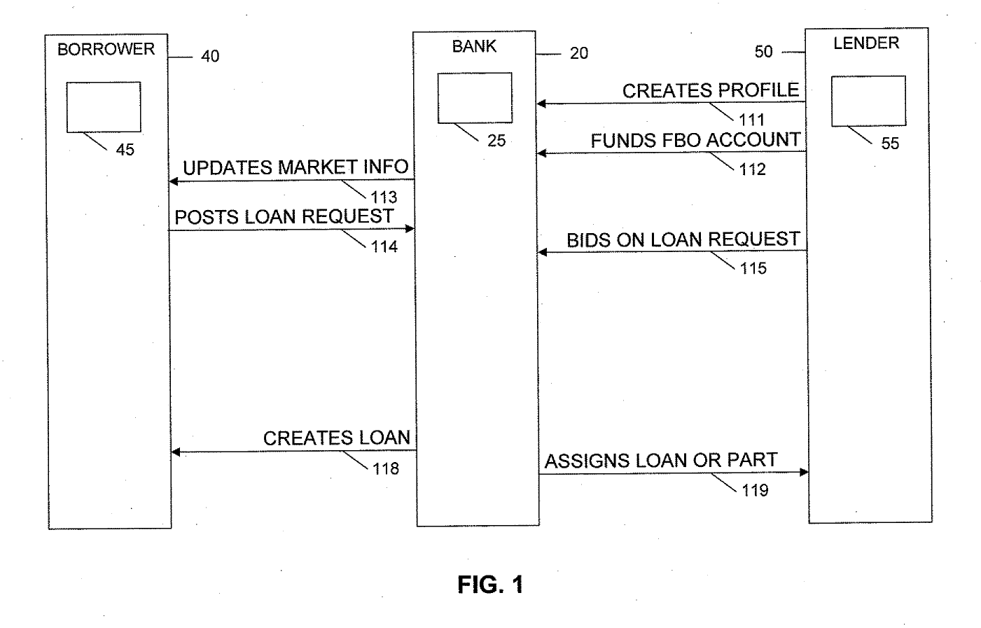

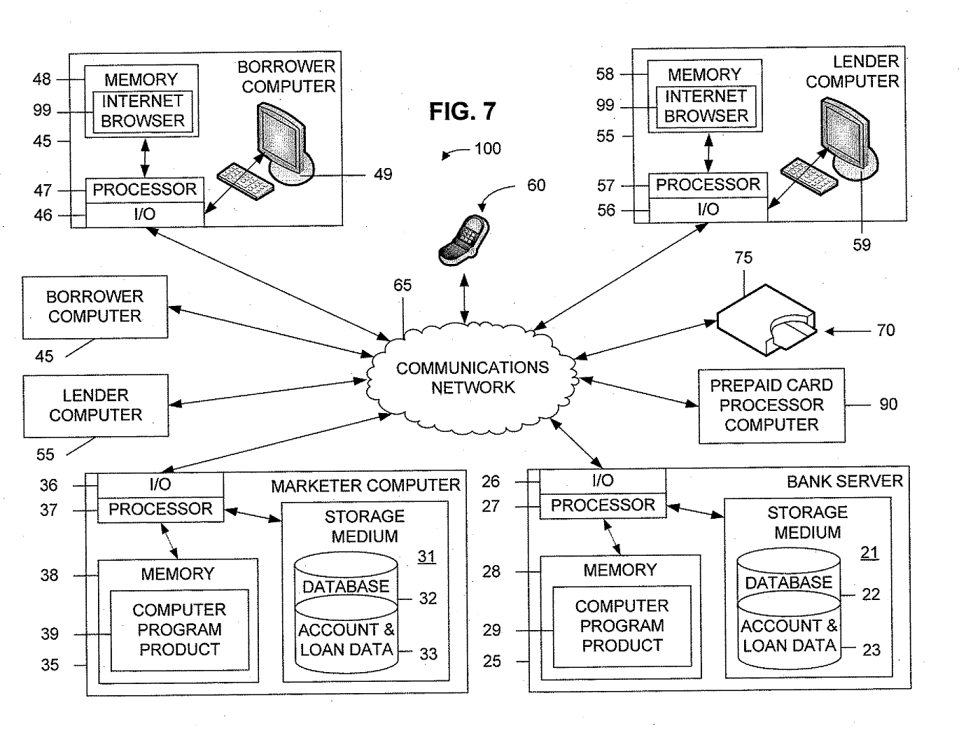

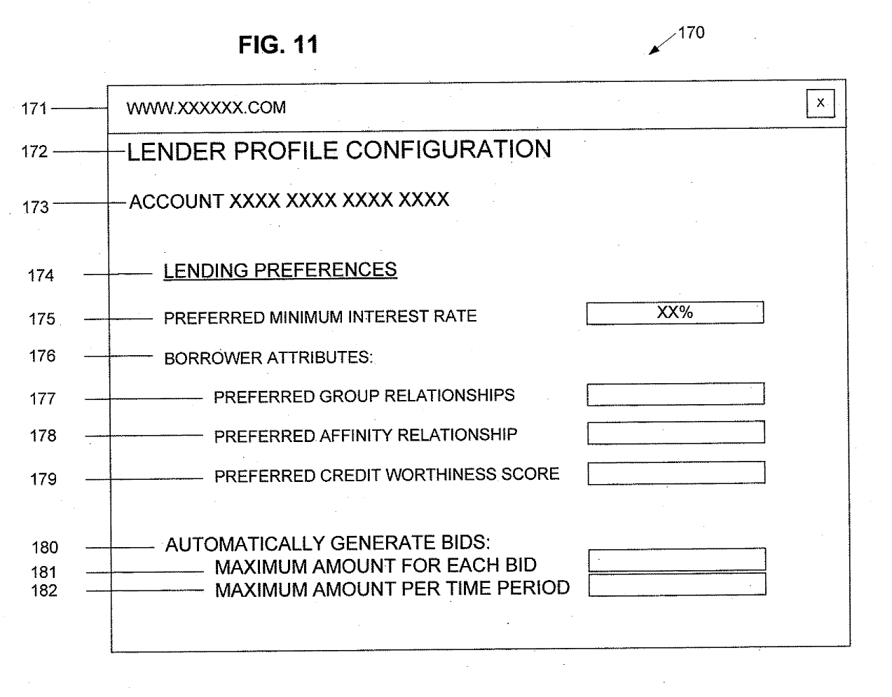

Example embodiments include technology for constructing a person-to-person loan transaction between an individual lender and an individual borrower with a bank serving as an intermediary. As illustrated in FIG. 1, the bank can be directly involved in promoting the person-to-person lending marketplace. Through a bank server 25, the bank 20 can provide an electronic forum, i.e., an interactive website or websites, promoting person-to-person loan transactions. The website can comprise a plurality of web pages in HTML and other languages viewable through an Internet or web browser (see, e.g., item 99 in FIG. 7), such as, Microsoft Corporation's Internet Explorer and others as understood by those skilled in the art. The lender 50, i.e., one or more individual lender of a plurality of lenders, can access the electronic forum on the bank server 25 through a lender computer 55 to create a profile as shown at 111. See also, e.g., FIG. 11. The lender profile can include information about the lender used to assign a loan to the lender 50, including a lender's name, address, and contact information. Such information may be confidential and not published by the bank 20 on the electronic forum. The lender profile can also include information about the lender's preferences regarding prospective borrowers 40. For example, a lender 50 may prefer to only lend to single parents, or a lender may prefer to exclude borrowers 40 who reside in California. Such preference information may not be confidential. In addition, the bank 20 can receive funds from the lender 50, including electronic transfers initiated through the lender computer 55 as understood by those skilled in the art, as shown at 112 and can maintain the lender's funds in a “for the benefit of (”FBO″) account at the bank 20 as understood by those skilled in the art. With funds on hand in the FBO account, the bank 20 can, through the bank server 25, update and publish market information regarding person-to-person loans as shown at 113. Such market information is viewable through a borrower computer 45 as understood by those skilled in the art. For example, if the lender 50, through the lender profile, has indicated a willingness to loan a certain amount of funds, e.g., $5,000, at interest rates above twenty-five percent (25%), the bank 20 through the bank server 25 can augment current data to include this additional amount. The borrower 40, i.e., one or more individual borrowers of a plurality of individual borrowers, can post a loan request through the borrower computer 45 as shown at 114. The loan request may include information about the borrower and the loan. For example, the loan request may include a purpose for the loan (i.e., why the borrower wants the money) and information about the borrower, including group and affinity relationships. As understood by those skilled in the art, some of the information from the borrower may be verified by the bank or supported by documentation provided by the borrower, including a credit score and other financial information, although other information may not be verified. For example, how the borrower 40 intends to spend the money from the loan may not be verified by the bank 20, either before or after a loan is made. In addition, the bank server 25 may automate some of the verification processes by accessing other computers as understood by those skilled in the art. Once the borrower's loan request is posted 114 at the bank server 25, the lender can bid on the loan request through a lender computer 55 as shown at 115. As understood by those skilled in the art, the bidding typically works as an auction, with lower interest rate bids winning over higher interest rate bids. In addition, a bid does not need to satisfy the entire amount of the loan request; multiple bids may be aggregated by the bank server 25 to satisfy the loan request according to embodiments of the present invention. For example, a loan request of $2,000 to take a vacation may be satisfied by two (2) bids of $500 and ten (10) bids of $100. When the bidding is complete, according to terms of the auction, and the loan amount is complete, the bank server 25 creates a loan to the borrower as shown at 118. Then the bank server 25 assigns the loan or part of the loan to the lender as shown at 119, corresponding to the bid by the lender. It will be understood by those skilled in the art that the bank may actually create multiple loans with the borrower, corresponding to multiple bids from multiple lenders, so that each of the multiple loans between the borrower and the bank can be assigned to a different lender.

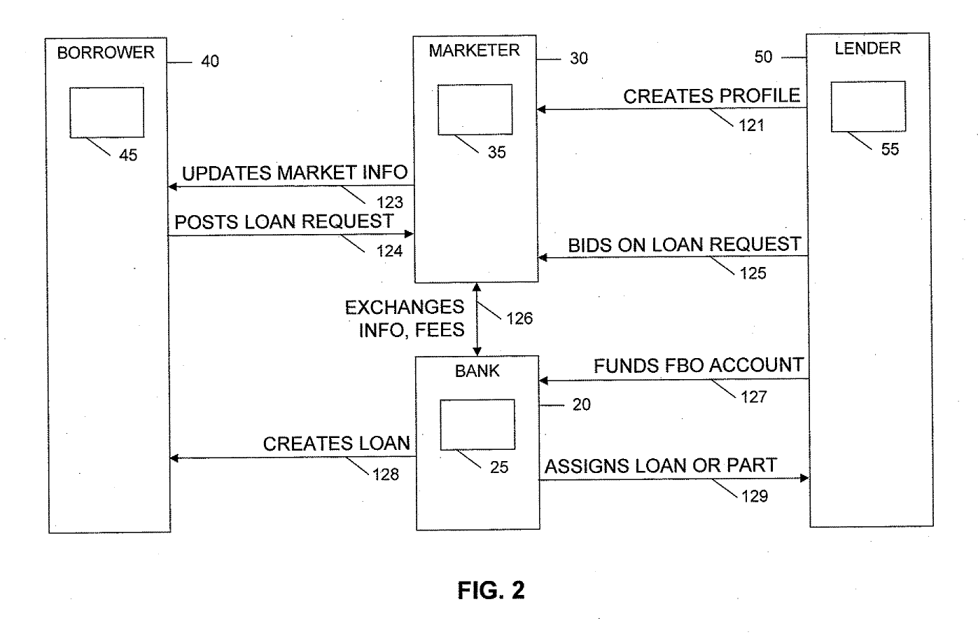

As illustrated in FIG. 2, example embodiments include technology for a marketer of person-to-person lending 30 to utilize a bank 20 as an intermediary to construct a person-to-person loan transaction; in this example, the bank 20 may be indirectly involved in promoting the person-to-person lending marketplace. Through a marketer computer 35, the marketer 30 can provide an electronic forum, i.e., an interactive website or websites, promoting person-to-person loan transactions. The lender 50, i.e., one or more individual lenders of a plurality of individual lenders, can access the electronic forum on the marketer computer 35 through a lender computer 55 to create a profile as shown at 121. See also, e.g., FIG. 11. In addition, the bank 20 can receive funds from the lender 50 as shown at 127, including electronic transfers initiated through the lender computer 55 as understood by those skilled in the art; the bank 20 can maintain the lender's funds in a “for the benefit of (”FBO″) account at the bank 20. With funds on hand in the FBO account at the bank 20, the marketer 30 can, through the marketer computer 35, update and publish market information regarding person-to-person loans as shown at 123. The borrower 40, i.e., one or more individual borrowers of a plurality of individual borrowers, can, through the borrower computer 45, post a loan request with the marketer 30 as shown at 124. The loan request may include information about the borrower 40 and the loan as described above. Once the borrower's loan request is posted, the lender 50 can bid on the loan request through the lender computer 55 as shown at 125. When the bidding is complete, according to terms of the auction, and the loan amount is complete, the bank server 25 can create a loan to the borrower 40 as shown at 128. Then the bank server 25 can assign the loan, or part of the loan, to the lender 50 as shown at 129. The bank 20 and marketer 30 can exchange information and fees, through the bank server 25 and marketer computer 35, as shown at 126 to coordinate the person-to-person loan transaction.

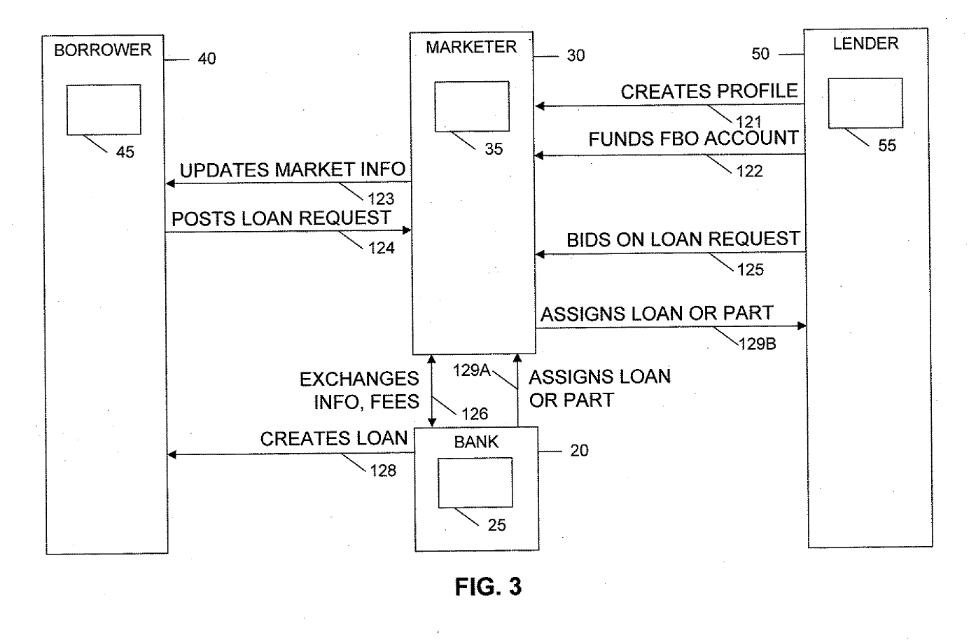

In an alternate embodiment as illustrated in FIG. 3, the lender 50, i.e., one or more individual lenders of a plurality of individual lenders, may direct funds to the marketer 30 as shown at 122, including electronic transfers initiated through the lender computer 55 as understood by those skilled in the art, so that the bank 20 may indirectly receive funds from the lender 50 through the marketer 30. In addition, after the bank server 25 creates the loan to the borrower 40 as shown at 128, the bank server 25 can assign the loan, or part of the loan, to the marketer 30 as shown at 129A, who in turn assigns the loan or part of the loan to the lender 50 as shown at 129B. That is, the bank 20 is a first intermediary, and the marketer 30 is a second intermediary, allowing the marketer 30 to control the customer relationship with the lender. As such, the bank 20 can generally act as a vendor to the marketer 30, perhaps allowing the bank 20 to perform similar services for multiple marketers.

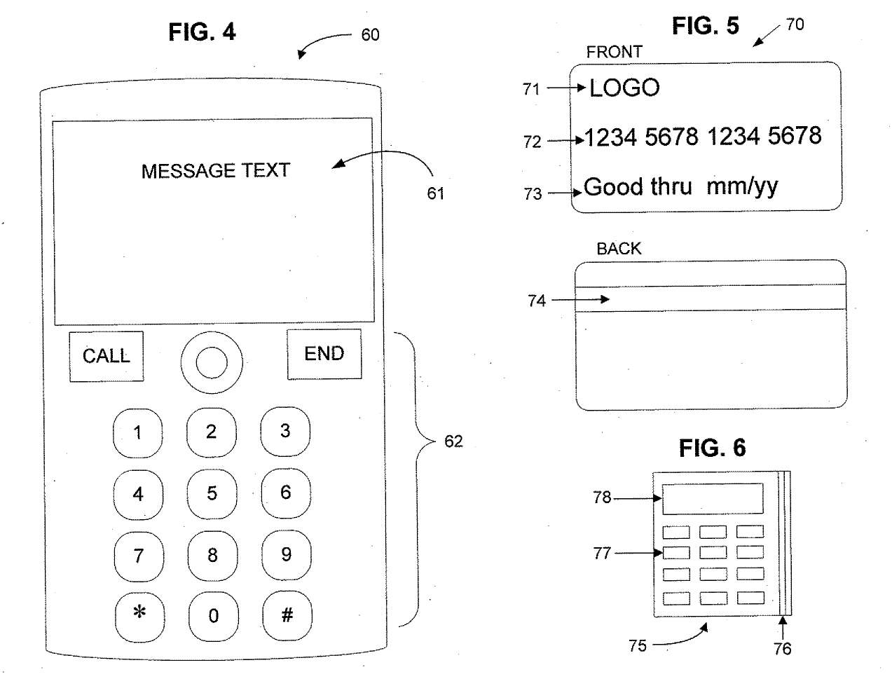

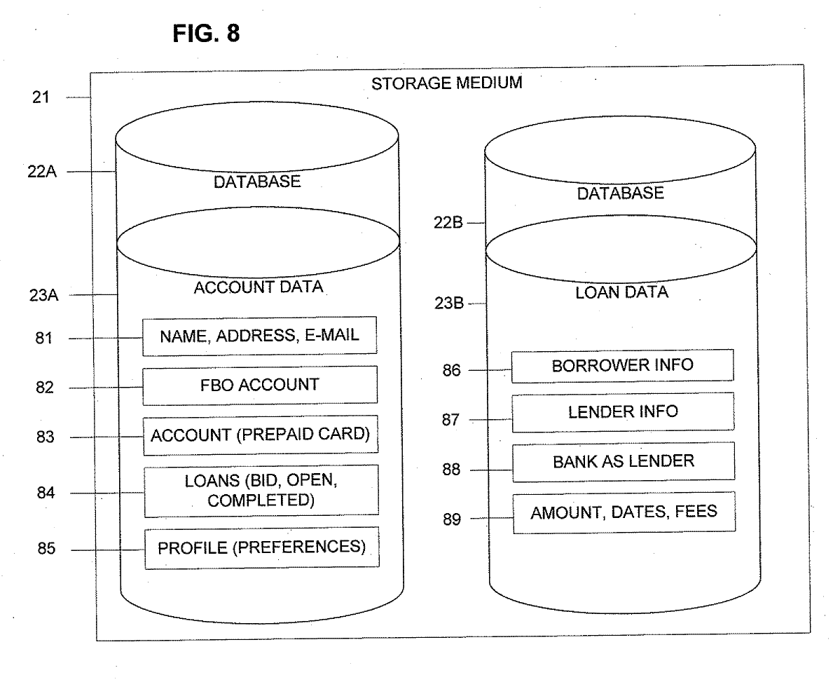

As illustrated in FIGS. 4-9, example embodiments include a system 100 to construct a person-to-person loan transaction so that a bank serves as an intermediary. The system 100 can include a first computer associated with the bank 20 and configured as a bank server 25 adapted to communicate with a second computer associated with a marketer for person-to-person lending 30 defining a marketer computer 35 so that a plurality of individual lenders 50 can bid on a plurality of person-to-person loan requests from a plurality of individual borrowers 40. The bank server 25 can include an input/output (I/O) interface 26; one or more processors 27; and tangible and non-transitory computer memory 28 containing computer program product 29. The bank server 25 can further include a tangible and non-transitory storage medium 21 containing a database 22 of account and loan data 23. See also, e.g., FIG. 8. The marketer computer 35 can include an input/output (I/O) interface 36; one or more processors 37; and computer memory 38 containing computer program product 39. The marketer computer 35 can further include a tangible and non-transitory storage medium 31 containing a database 32 of account and loan data 33. The marketer computer 35 is adapted to and configured to communicate through an electronic communications network 65 with a plurality of third computers 45 and a plurality of fourth computers 55. The plurality of third computers are associated with the plurality of individual borrowers 40 and configured as borrower computers 45. The plurality of fourth computers are associated with the plurality of individual lenders 50 and configured as lender computers 55. Each borrower computer 45 can include an input/output (I/O) interface 46; one or more processors 47; computer memory 48 containing an Internet browser 99; and a display 49. Each lender computer 55 can include an input/output (I/O) interface 56; one or more processors 57; tangible and non-transitory computer memory 58 containing an Internet browser 99; and a display 59. Borrower computers 45 and lender computers 55 can include smart phones 60, personal digital displays, and other interfaces. See, e.g., FIG. 4. As understood by those skilled in the art, a lender 50 can receive a text message 61 on a phone 60 alerting the lender to a new loan request that meets the lender's preferences; the lender 50 can then elect to bid on the loan request using the number keys 62 or keyboard interface of the phone 60. Each of the plurality of borrower computers 45 and the plurality of lender computers 55 are remote from the bank server 25, as understood by those skilled in the art.

As understood by those skilled in the art, the borrower computer 45 and the lender computer 55 embodiments can include personal or home computers. Various operating systems and hardware embodiments are included in the embodiments of the present invention. Example embodiments can further include network boxes, game systems, hand-held devices, mobile phones 60, are other such terminals as understood by those skilled in the art. A browser, e.g., Internet browser 99, or other program product as understood by those skilled in the art communicates through the electronic communications network 65, e.g., the Internet, cellular communications network, text messaging network, local are network (LAN), wide area network (WAN), and combinations thereof as understood by those skilled in the art, to interact with the marketer computer 35 (or the bank server 25) so that when accessed by the lender computer 55 or borrower computer 45, the marketer computer 35 (or bank server 25) executes operations as described herein to implement P2P transactions. In addition to browser-based implementations, custom applications can be loaded onto the borrower computer 45 or the lender computer 55; these custom application embodiments configure the computers to implement the transactions described herein and may be optimized for use on particular devices. For example, a smart phone application embodiment may be optimized for the screen and messaging services available with the smart phone device embodiments. For example, desktop widgets and other applications can configure and program the borrower computer 45 and the lender computer 55 embodiments as understood by those skilled in the art.

As understood by those skilled in the art, the marketer computer 35 and the bank server 25 embodiments can include industrial or commercial computers and can be configured as a computer, a server, or a system of distributed computers or servers that at least include memory 38, 28, program product 39, 29, one or more processors 37, 27, an input/output (I/O) interface 36, 26, as shown in FIG. 7. The computer I/O interfaces 36, 26 connect the computer 35, 25 to the other computers in system 100 through the electronic communications network 65. The input/output (I/O) interface 36, 26 can be any I/O device including, but not limited to a network card/controller connected by a PCI bus to the motherboard, or hardware built into the motherboard of the computer 35, 25 to connect same to the network. As can be seen, the input/output (I/O) interface 36, 26 is connected to the processor 37, 27. Processors 37, 27 of the marketer computer or bank server are the “brains” of the computer 35, 25, and as such executes program product 39, 29 and works in conjunction with the input/output (I/O) interface 36, 26 to direct data to the tangible and non-transitory memory 38, 28 and to send data from memory 38, 28 to the other computers in the system 100 as understood by those skilled in the art. Processor 37, 27 can be any commercially available processor, or plurality of processors, adapted for use for the computer 35, 25, e.g., Intel® Xeon® multicore processors, Intel® micro-architecture Nehalem, AMD Opteron™ multicore processors, etc. As one skilled in the art will appreciate, processor 37, 27 may also include components that allow the computer 35, 25 to be connected to a display [not shown] and keyboard that would allow a user to directly access the processor 37, 27 and memory 38, 28.

The system 100 can further include a prepaid card processor computer 90 so that when the bank server 25 initiates a loan with the borrower, loan proceeds are loaded onto a prepaid card 70 associated with the borrower 20. As illustrated in FIG. 5, embodiments of the present invention can include, for example, a prepaid card 70. As understood by those skilled in the art, a prepaid card can have indicia 71, e.g., logos, slogans, source identifiers, of a sponsoring bank 20 and of a prepaid card processor 90; a serial number 72; and expiration date 73. The structures of various types of specific cards, e.g., magnetic stripe 74, and types of material are well known to those skilled in the art and can be used with embodiments of the present invention. Typically, a card 70 is formed from plastic and has a magnetic stripe 74 affixed to the plastic through an application of heat. Those skilled in the art will understand that other embodiments besides a magnetic stripe can include radio frequency identification devices (RFID), smart chips, bar codes, and other similar devices. Embodiments of the present invention can include forming cards or receiving cards already formed. The magnetic stripe card 70 can store information, or data, e.g., account information, by modifying the magnetism of particles on the magnetic stripe 74 on the card. As illustrated in FIG. 6, prepaid card data can be read by swiping the card through a slot 76 past a reading head of a card reader device, including most point-of-sale hardware 75. The point-of-sale hardware can include a keypad 77 to input transaction information, such as a sales price, and a display 78 to indicate approval or rejection. Typically, there are two tracks of data on a magnetic card used for financial transactions, known as tracks 1 and 2. In addition, a third track, known as track 3, can be available for magnetic stripe cards. Tracks 1 and 3, if available, are typically recorded at 210 bits per inch, while track 2 typically has a recording density of 75 bits per inch. Track 2, as typically encoded, was developed by the American Bankers Association (“ABA”) provides for 37 numeric data characters, including up to 19 digits for a primary account number (including a Bank Identification Number as understood by those skilled in the art), an expiration date, a service code, and discretionary verification data, such as, a Personal Identification Number, or PIN. The data on the card can be used, for example, to facilitate a transaction. For example, when the card 70 is swiped through a slot 76, the data on the magnetic stripe 74 is read and processed by the reader 75. The reader 75 can then communicate through an electronic communications network 65 to, for example, a prepaid card processor 90 or a bank server 25. The card reader, e.g., point of sale 75, communicates the account data as read from the card, as well as other data, such as, an amount of a proposed transaction for approval. The other data, for example, can be entered by merchant personnel (e.g., an amount of the transaction), the consumer (e.g., a PIN, or security code), or bank personnel (e.g., a security approval). The prepaid card processor 90 or bank server 25 can then utilize the account information and other information or data to authorize or reject a purchase by, for example, determining whether a proposed purchase by the consumer is less than an amount of funds remaining in the account, e.g., on the card. Moreover, optional security measures, including, for example, a mismatch between a PIN supplied by the consumer and a PIN stored on the card or in a database, can result in the rejection of a proposed transaction. Also, prepaid card processor computer 90 can, for example, write data to a database to record a transaction, to debit available funds from an account associated with the prepaid card 70, and to credit directly or indirectly a merchant for a purchase. In addition to purchase authorization, embodiments of the present invention also can include customer inquiries into recent transactions or a balance inquiry, i.e., an amount of remaining value associated with the prepaid card.

The bank server 25 can further include a storage medium 21 containing at least one database 22 of account and loan data 23. As illustrated in FIG. 8, storage medium 21 contains database 22A containing account data 23A and database 22B containing loan data 23B. Account data 23A can include a name, address, and e-mail 81 for the borrower 40 or lender 50. For a lender 50, account data 23A can also include FBO account information 82. For a borrower 40, account data 23A can include account information 83 for sending the loan proceeds, including a prepaid card account associated with the borrower 40. Account data 23A can include information on loans 84, including loans bid, open, and completed. Account data 23A can include a lender profile 85, including preferences as described herein. Loan data 23B can include borrower information 86, lender information 87, and a record 89 of amount, dates and fees associated with a loan. In addition, loan data 23B can include information regarding the bank as a lender 88 when the bank 20 participates in the person-to-person loan transaction as a lender, perhaps to complete a loan request not satisfied by lender bids in the person-to-person marketplace. Those skilled in the art will understand other implementations and organizational structures to with the scope of the embodiments of the present invention.

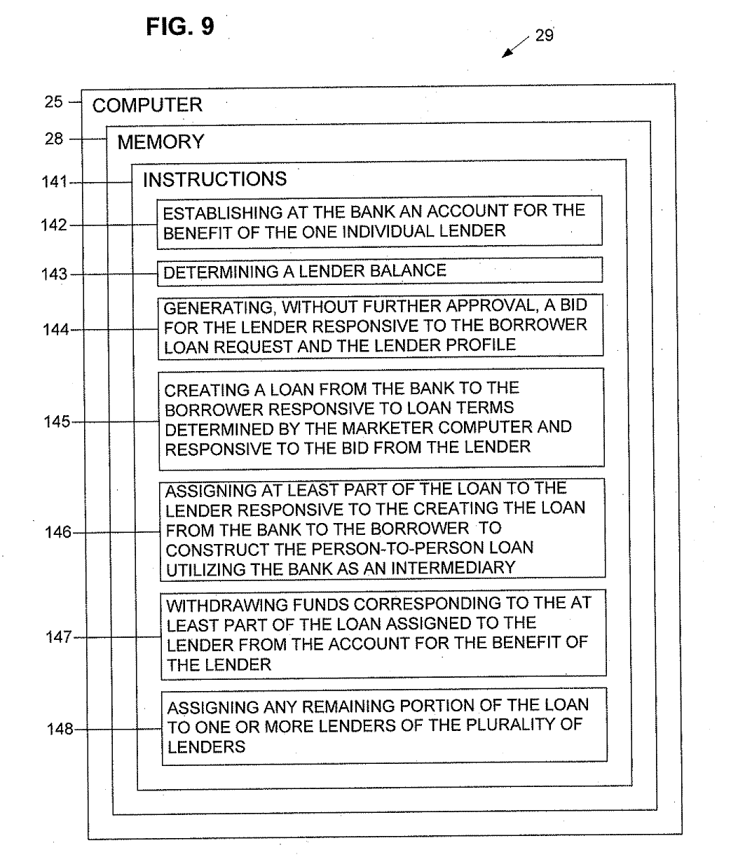

As illustrated in FIG. 9, the bank server 25 can include a computer program product 29 according to an example embodiment. The computer program product 29 can be operable on the bank server 25 and stored in the tangible and non-transitory memory 28 of the bank server 25. The computer program product 29 includes a set of instructions 141 that, when executed by the bank server 25, cause the bank server 25 to perform various operations. The operations can include establishing at the bank an account for the benefit of the individual lender as shown at 142. The operations can include determining for the account a balance for the lender 50 as shown at 143. The lenders balance can limit a bid from the lender 50 responsive to a person-to-person loan request by the borrower. That is, a lender may not be able to bid more than the balance in the FBO account. The lenders balance can also augment a person-to-person lending profile for the lender so that a marketer 30 can update market information with concrete information for the amounts lenders are willing to lend. The person-to-person lending profile for the lender can include preferences for the lender. The operations can include generating, without further approval from the lender, a bid for the lender responsive to the person-to-person loan request by the borrower and responsive to the person-to-person lending profile for the lender as shown at 144. The operations can include creating the loan from the bank to the borrower responsive to loan terms determined by the marketer computer and responsive to the bid from the lender as shown at 145. The operations can include assigning at least part of the loan to the lender responsive to the bid from the lender to construct the person-to-person loan utilizing the bank as an intermediary as shown at 146. The operations can include withdrawing funds corresponding to the at least part of the loan assigned to the lender from the account for the benefit of the lender as shown at 147. The operations can include assigning any remaining portion of the loan to one or more lenders of the plurality of individual lenders responsive to loan terms determined by the marketer computer and responsive to the one or more bids from the one or more lenders of the plurality of individual lenders as shown at 148.

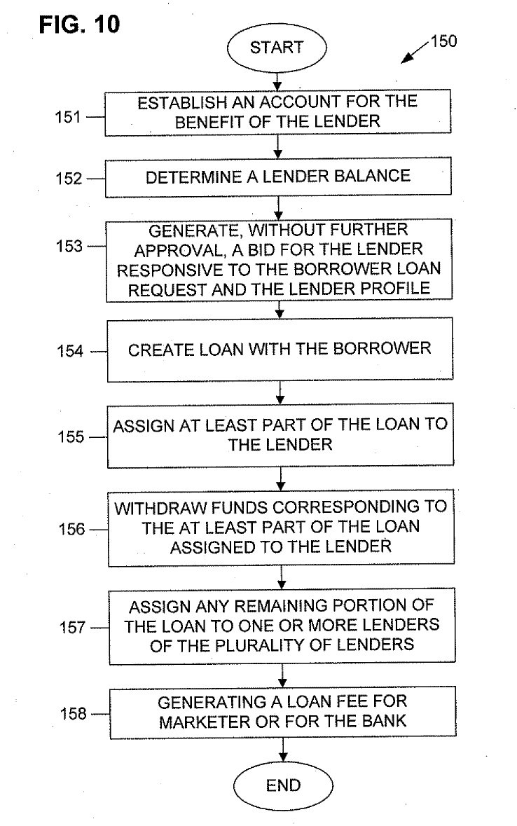

As illustrated in FIG. 10, an example embodiment can include a computer-implemented method 150 for causing a first computer associated with a bank and configured as a bank server to perform a process of creating a loan from a bank to an individual borrower and a process of assigning at least part of the loan from the bank to an individual lender to construct a person-to-person loan so that a bank serves as an intermediary. The computer-implemented method 150 can include establishing at the bank an account for the benefit of the individual lender as shown at 151. The computer-implemented method 150 can include determining for the account a balance for the lender 50 as shown at 152. The lenders balance can limit a bid from the lender responsive to a person-to-person loan request by the borrower and can augment a profile for the lender. The computer-implemented method 150 can include generating, without further approval from the lender, a bid for the lender responsive to the person-to-person loan request by the borrower and responsive to the person-to-person lending profile for the lender as shown at 153. The computer-implemented method 150 can include creating the loan with the borrower responsive to loan terms determined by the marketer computer and responsive to the bid from the lender as shown at 154. The computer-implemented method 150 can include assigning at least part of the loan to the lender responsive to the bid from the lender to construct the person-to-person loan utilizing the bank as an intermediary as shown at 155. The computer-implemented method 150 can include withdrawing funds corresponding to the at least part of the loan assigned to the lender from the account for the benefit of the lender as shown at 156. The computer-implemented method 150 can include assigning any remaining portion of the loan to one or more lenders of the plurality of lenders responsive to loan terms determined by the marketer computer and responsive to one or more bids from the one or more lenders of the plurality of lenders as shown at 157. The computer-implemented method 150 can include generating a loan fee for the bank 20 or for the marketer 30 as shown at 158.

As illustrated in FIG. 11, a lender profile configuration interface 170 according to an embodiment of the present invention can be accessed through an Internet or web address 171, using, for example, an Internet browser 99 and display screen 59 of a lender computer 55. (See, e.g., FIG. 7.) The lender profile configuration interface 170 can include a title as shown at 172 or other indicia of its purpose. The lender profile configuration interface 170 can include an associated account number as shown at 173. The lender profile configuration interface 170 can also include lending preferences 174 for the lender associated with the lending profile. For example, the person-to-person lending profile for the lender can include preferences for the lender for a preferred minimum interest rate 175. For example, the person-to-person lending profile for the lender can include preferences for the lender for a preferred group relationship 177 for the borrower requesting the loan. For example, the person-to-person lending profile for the lender can include preferences for the lender for a preferred affinity relationship 178 for the borrower requesting the loan. For example, the person-to-person lending profile for the lender can include borrower attributes 176. The borrower attributes 176 can include, for example, preferences for the lender for a preferred indication of credit worthiness 179 for the borrower requesting the loan, such as a preferred credit score for the borrower. In addition, the person-to-person lending profile for the lender can include a preference for automatically generating bids for the lender as shown at 180, including a maximum amount for each bid 181 and a maximum amount per time period 182 (e.g., limiting loans to a $200 per week, $400 per month, $1000 per quarter, and another amount as understood by those skilled in the art).

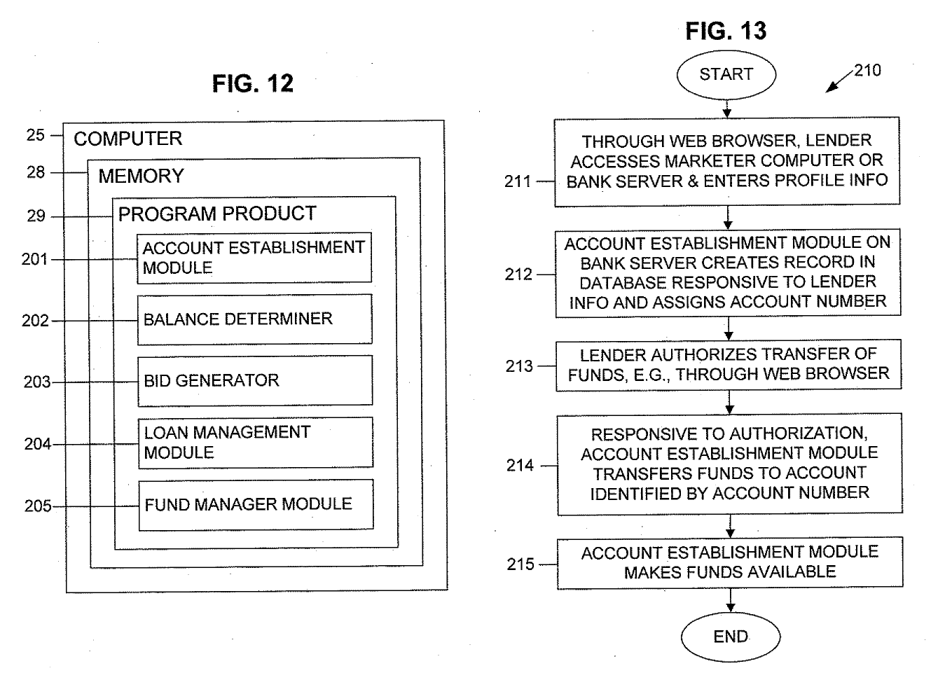

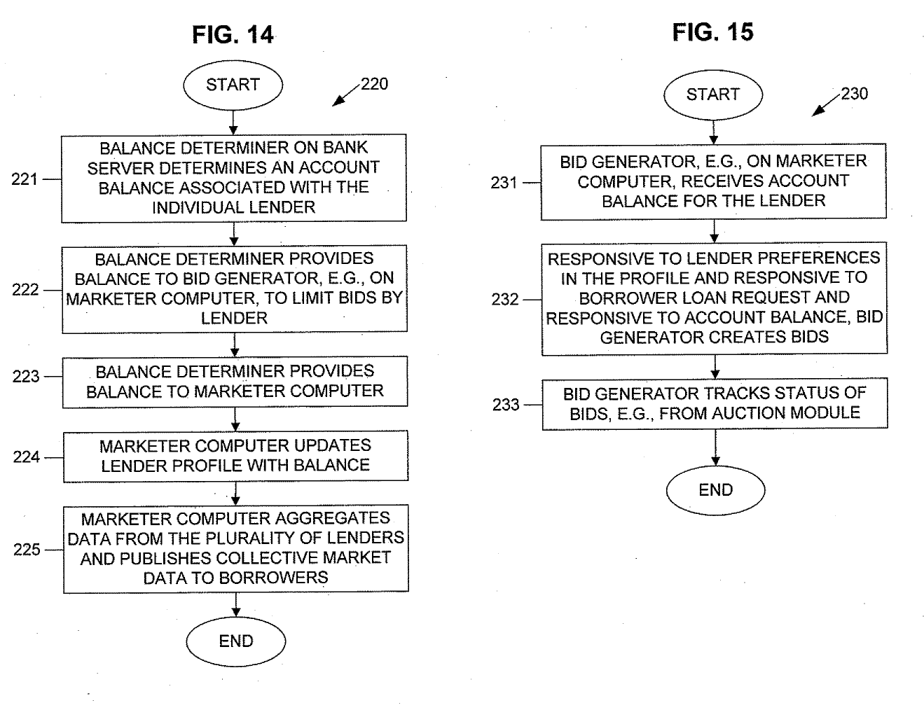

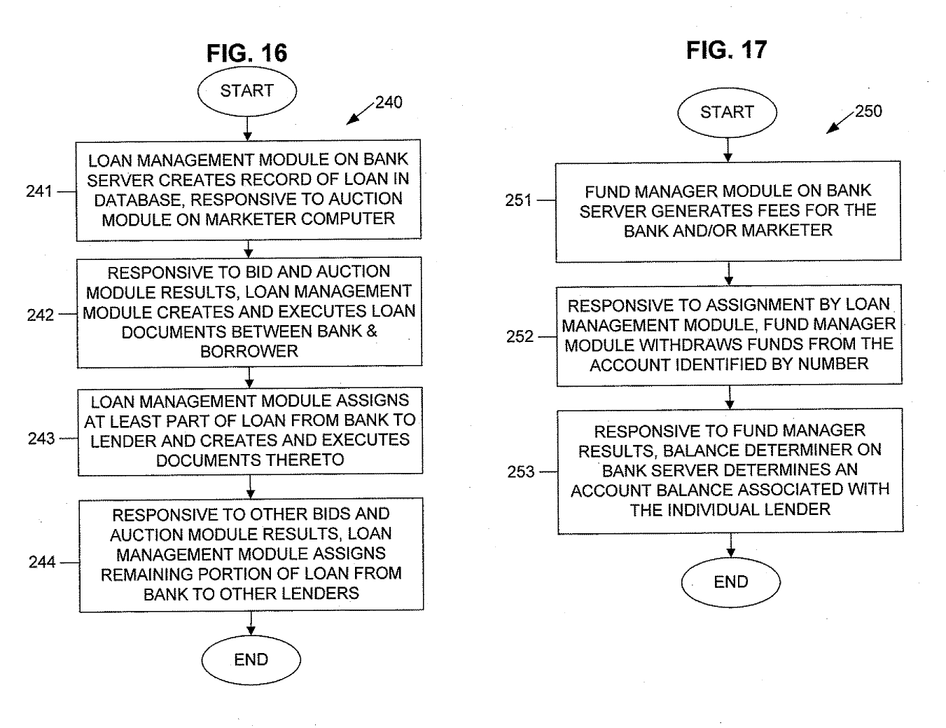

As illustrated in FIG. 12, the bank server 25 can include a computer program product 29 according to an example embodiment. The computer program product 29 can be operable on the bank server 25 and stored in the tangible and non-transitory memory 28 of the bank server 25. The computer program product 29 embodiments can include a series of modules that each provide results and together interact according to the embodiments of the present invention. The module embodiments can include, for example, an account establishment module 201 (see, e.g., FIG. 13); a balance determiner 202 (see, e.g., FIG. 14); a bid generator 203 (see, e.g., FIG. 15); a loan management module 204 (see, e.g., FIG. 16); and fund manager module 205 (see, e.g., FIG. 17).

As illustrated in FIG. 13, an account establishment module 210 embodiment can, for example, operate on a bank server 25 to perform a method 210. To establish an FOB account at the bank 20 for the individual lender 50, the individual lender 50 can access the marketer computer 35 through a web browser 99 operating on the lender computer 55 to enter profile information as described herein as shown at 211. Responsive to the individual lender profile information, as understood by those skilled in the art, the account establishment module 210 can create a record in the database for the individual lender (see, e.g., 82 in FIG. 8) and assign an account number as shown at 212. The individual lender 50 then authorizes the transfer of funds to the account 82 as shown at 213. For example, the individual lender 50 can utilize a web browser 99 operating on the lender computer 55 to authorize transfer of funds from various sources, including another account the bank 20, an account at another financial institution, e.g., utilizing a paper or electronic check, a debit or credit card account, and others as understood by those skilled in the art. The account establishment module 210 can then transfer funds as shown at 214 to the account 82 identified by the account number responsive to the authorization by the individual lender 50. Upon receipt, the account establishment module 210 can make funds available for person-to-person loans as described herein as shown at 215.

As illustrated in FIG. 14, a balance determiner module 220 can, for example, operate on a bank server 25 to perform a method 220. The balance determiner module 220 determines an account balance associated with the individual lender 50 as shown at 221. The balance determiner 220 can provide the balance result to a bid generator 230, for example, operating on the bank server 25 or the marketer computer 35, to limit bids by the individual lender 50 as shown at 222, including manually-generated, automatically-generated bids, or a combination of both. The balance determiner 220 can provide the balance result to the marketer computer 35 as shown at 223 so that the marketer computer 35 can update the lender profile with balance information as shown at 224. The market computer 35 can then aggregate data from the plurality of individual lenders 50 and publish this collective market data to borrowers 40 as shown at 225.

As illustrated in FIG. 15, a bid generator module 230 can, for example, operate on a bank server 25 (as shown in FIG. 12) or on the marketer computer 35 (see, e.g., 39 in FIG. 7), to perform a method 230. The bid generator module 230 receives account balance results for the individual lender 50 from the balance determiner 220 as shown at 231. Responsive to lender preferences in the profile, an individual borrower loan request, and the account balance results from the balance determiner 220, the bid generator module 230, as will be understood by those in the art, can create and submit to an auction module (not shown) bids for various individual borrower loan requests as shown at 232. Responsive to results from the auction module, the bid generator 230 can track the status of the bids as shown at 233.

As illustrated in FIG. 16, a loan management module 240 can, for example, operate on a bank server 25 (as shown in FIG. 12), to perform a method 240. The loan management module 240 can create a record of the loan in the database (see, e.g., FIG. 8) responsive to the auction module results from the marketer computer 35 as shown at 241. Responsive to a bid from the individual lender (including an automatic bid generated by the bid generator as shown in FIG. 15) and responsive to the auction module results, the loan management module 240 can create and execute loan documents between the bank 20 and individual borrower 40 as shown at 242. The loan management module 240 can then assign at least part of the loan from the bank 20 to the individual lender 50 and create and execute loan documents thereto as shown at 243. Responsive the other bids and responsive to the auction module results, the loan management module 240 can assign any remaining portion of the loan from the bank 20 to the other individual lenders and create and execute loan documents thereto as shown at 244.

As illustrated in FIG. 17, a fund manager module 250 can, for example, operate on a bank server 25 (as shown in FIG. 12), to perform a method 250. The fund manager module 250 can generate fees for the bank 20, for the marketer 30, or both as shown at 251. Responsive to the assignment by the loan management module 204 (see, e.g., 243 in FIG. 16), the fund manger module 250 can withdraw funds from the FOB account 82 identified by the account number as shown at 252. As understood by those skilled in the art, withdrawing these funds makes the bank whole and ends the bank's risk of default by the individual borrower 40 with respect to the loan. As understood by those skilled in the art, the individual lender 50 is assigned the risk resulting in a person-to-person loan. Responsive to the fund manager module 250 results, the balance determiner module 220 can determine a new or update or current account balance associated with the individual lender 50 as shown as 253. See also, e.g., FIG. 14.

A person having ordinary skill in the art will recognize that various types of memory are readable by a computer such as described herein, e.g., bank server, marketer computer, borrower computer, lender computer, prepaid card processor computer, or other computers within the embodiments of the present invention. Examples of computer readable media include but are not limited to: nonvolatile, hard-coded type media such as read only memories (ROMs), CD-ROMs, and DVD-ROMs, or erasable, electrically programmable read only memories (EEPROMs), recordable type media such as floppy disks, hard disk drives, CD-R/RWs, DVD-RAMs, DVD-R/RWs, DVD+R/RWs, flash drives, memory sticks, and other newer types of memories, and transmission type media such as digital and analog communication links. For example, such media can include operating instructions, as well as instructions related to the system, program products, and the method steps described above and can operate on a computer. It will be understood by those skilled in the art that such media can be at other locations instead of or in addition to the locations described to store program products, e.g., including software, thereon. Embodiments of a system can include multiple computers as illustrated and described herein and one or more remote computer servers positioned to provide communication with each of the plurality of lender and borrower computers. Each of these computer, for example, can having one or more of these various types of memory, i.e., tangible and non-transitory memory, as understood by those skilled in the art.

Many modifications and other embodiments of the invention will come to the mind of one skilled in the art having the benefit of the teachings presented in the foregoing descriptions and the associated drawings. Therefore, it is to be understood that the invention is not to be limited to the illustrated embodiments disclosed, and that modifications and other embodiments are intended to be included within the scope of the appended claims.

That claimed is:

1. A machine to perform a process of creating a loan from a bank to one ore more individual borrowers of a plurality of individual borrowers and a process of assigning at least part of the loan from the bank to one or more individual lenders of a plurality of individual lenders to construct a person-to-person loan transaction between the one or more individual lenders and the one individual borrower, the machine comprising:
a first computer having at least a processor and a tangible, non-transitory memory and being associated with the bank to thereby define a bank server, the bank server adapted to communicate with a second computer associated with a person-to-person lending marketer to thereby define a marketer computer, the marketer computer being adapted to communicate through an electronic communications network with a plurality of third computers associated with the plurality of individual borrowers to thereby define a plurality of borrower computers and a plurality of fourth computers associated with the plurality of individual lenders to thereby define a plurality of lender computers so that the marketing computer processes a plurality of person-to-person loan requests from the plurality of borrower computers and a plurality of bids for person-to-person loans from the plurality of lender computers responsive to the plurality of person-to-person loan requests, the plurality of borrower computers and the plurality of lender computers each being remote from the bank server; and
computer program product operable on the bank server and stored in the non-transitory memory of the bank server to construct the person-to-person loan transaction between the plurality of individual lenders and one or more of the plurality of individual borrower, the computer program product comprising a set of instructions that, when executed by the bank server, cause the bank server to perform the operations of:
establishing with the bank server an account at the bank for the benefit of one or more individual lenders of the plurality of individual lenders, the account being identified by an account number so that the bank controls funds associated with the one or more individual lenders and the funds being available for person-to-person lending through the marketer computer,
determining a balance for the account for the benefit of the one or more individual lenders to thereby define a lenders balance so that when communicated to the marketer computer from the bank server the lenders balance limits a bid for a person-to-person loan from the one or more individual lenders responsive to a person-to-person loan request by the one individual borrower, the lenders balance also augments a person-to-person lending profile for the one individual lender, the person-to-person lending profile including preferences of the one or more individual lenders,
creating the loan from the bank to the one or more individual borrowers responsive to receiving loan terms determined by the marketer computer and responsive to the bid for the person-to-person loan from the one or more individual lenders,
assigning at least part of the loan from the bank to the one or more individual lenders responsive to creating the loan from the bank to the one or more individual borrowers to construct the person-to- person loan transaction between the one individual borrower and the one or more individual lenders so that the bank serves as an intermediary for the person-to-person loan transaction, and
withdrawing funds from the account for the benefit of the one or more individual lenders corresponding to the at least part of the loan assigned to the one or more individual lenders.

2. A machine as defined in claim 1, wherein the marketer computer publishes aggregate funds available from the plurality of individual lenders for person-to-person lending and wherein the one or more individual lenders is a first individual lender of the plurality of individual lenders; and wherein the operations further comprise:
assigning any remaining portion of the loan from the bank to one or more second individual lenders of the plurality of individual lenders responsive to assigning the at least part of the loan from the bank to the first individual lender.

3. A machine as defined in claim 1, wherein the funds associated with the one or more individual lenders are being transferred from the one or more individual lenders to the marketer computer and subsequently transfer to the account at the bank for the benefit of one or more individual lenders; and wherein the at least part of the loan is being assigned from the bank to the person-to-person lending marketer and subsequently assign to the one or more individual lenders so that the person-to-person lending marketer serves as the intermediary for the person-to-person loan transaction.

4. A machine as defined in claim 1, wherein the person-to-person lending profile for the one or more individual lenders includes one or more of the following preferences declared by the one or more individual lenders: a preferred interest rate, a preferred group relationship for the one or more individual borrower requesting the loan, a preferred affinity relationship for the one or more individual borrower requesting the loan, a preferred indication of credit worthiness for the one or more individual borrower requesting the loan, and a preferred credit score for the one or more individual borrower. .

5. A machine as defined in claim 1, wherein the bank is federally-chartered bank subject to federal banking laws and regulations so that state banking laws and regulations are preempted; and wherein the operations further comprising:
loading proceeds from the loan onto a prepaid card associated with the one or more individual borrowers.

6. A machine as defined in claim 1, wherein the operations further comprise:
generating a loan fee for the bank; and
generating a loan fee for the person-to-person lending marketer.

7. A machine as defined in claim 1, wherein the marketer computer publishes aggregate preferences for the plurality of individual lenders to thereby promote funds available for person-to-person lending for one or more borrowers that fit the preferences; and wherein the bank is a first bank and acts as a first intermediary for the person-to-person loan transaction and the operations further comprising:
assigning at least a second part of the loan from the first bank to a second bank so that the second bank serves as a second intermediary for the person-to-person loan transaction.

8. A computer program product operable on a first computer associated with a bank to thereby define a bank server and stored in a tangible, non-transitory computer memory media to construct the person-to-person loan transaction between the plurality of individual lenders and one or more of the plurality of individual borrower, the computer program product comprising a set of instructions that, when executed by the bank server, cause the bank server to perform the operations of:
establishing with the bank server an account at the bank for the benefit of one or more individual lenders of a plurality of lenders, the account being identified by an account number so that the bank controls funds associated with the one or more individual lender, the funds being available for person-to-person lending through a second computer associated with a person-to-person lending marketer to thereby define a marketer computer, the marketer computer being adapted to communicate through an electronic communications network with a plurality of third computers associated with a plurality of individual borrowers defining a plurality of borrower computers and a plurality of fourth computers associated with the plurality of individual lenders defining a plurality of lender computers so that the marketing computer processes a plurality of person-to-person loan requests from the plurality of borrower computers and a plurality of bids for person-to-person loans from the plurality of lender computers responsive to the plurality of person-to-person loan requests, the plurality of borrower computers and the plurality of lender computers each being remote from the bank server;
determining a balance for the account for the benefit of the one or more individual lenders to thereby define a lenders balance so that when communicated to the marketer computer from the bank server the lenders balance limits a bid for a person-to-person loan from the one or more individual lenders responsive to a person-to-person loan request by the one individual borrower, the lenders balance also augments a person-to-person lending profile for the one or more individual lender, the person-to-person lending profile including preferences of the one or more individual lender;
creating a loan from the bank to the one individual borrower responsive to receiving loan terms determined by the marketer computer and responsive to the bid for the person-to-person loan from the one or more individual lenders;
assigning at least part of the loan from the bank to the one or more individual lenders responsive to creating the loan from the one or more individual borrowers to construct the person-to-person loan transaction between the one individual borrower and the one or more individual lenders so that the bank serves as an intermediary for the person-to-person loan transaction; and
withdrawing funds from the account for the benefit of the one or more individual lenders corresponding to the at least part of the loan assigned to the one or more individual lenders.

9. A computer program product as defined in claim 8, wherein the one or more individual lenders of the plurality of individual lenders is a first individual lender of the plurality of individual lenders; and wherein the operations further comprise:
assigning any remaining portion of the loan from the bank to one or more second individual lenders of the plurality of individual lenders responsive to assigning the at least part of the loan from the bank to the first individual lender.

10. A computer program product as defined in claim 8, wherein the person-to-person lending profile for the one or more individual lenders includes one or more of the following preferences declared by the one or more individual lenders: a preferred interest rate, a preferred group relationship for the one or more individual borrower requesting the loan, a preferred affinity relationship for the one or more individual borrower requesting the loan, a preferred indication of credit worthiness for the one or more individual borrower requesting the loan, and a preferred credit score for the one or more individual borrower.

11. A computer program product of claim 8, wherein the bank is federally-chartered bank subject to federal banking laws and regulations so that state banking laws and regulations are preempted; and wherein the operations further comprising:
loading proceeds from the loan onto a prepaid card associated with the one or more individual borrowers.

12. A computer program product as defined in claim 8, wherein the operations further comprise:
generating a loan fee for the bank; and
generating a loan fee for the person-to-person lending marketer.

13. A computer program product as defined in claim 8, wherein the marketer computer publishes aggregate preferences for the plurality of individual lenders to thereby promote funds available for person-to-person lending for one or more borrowers that fit the preferences; and wherein the bank is a first bank and acts as a first intermediary for the person-to-person loan transaction and the operations further comprising:
assigning at least a second part of the loan from the first bank to a second bank so that the second bank serves as a second intermediary for the person-to-person loan transaction.

14. A computer-implemented method for causing a first computer associated with a bank and having at least a processor and a tangible, non-transitory memory to thereby define a bank server to perform a process of creating a loan from the bank to one or more individual borrowers of a plurality of individual borrowers and a process of assigning at least part of the loan from the bank to one or more individual lenders of a plurality of individual lenders to construct a person-to-person loan transaction between the one or more individual lenders and the one individual borrower, the computer-implemented method comprising:
establishing with the bank server an account at the bank for the benefit of one or more individual lenders of a plurality of lenders, the account being identified by an account number so that the bank controls funds associated with the one or more individual lender, the funds being available for person-to-person lending through a second computer associated with a person-to-person lending marketer to thereby define a marketer computer, the marketer computer being adapted to communicate through an electronic communications network with a plurality of third computers associated with a plurality of individual borrowers defining a plurality of borrower computers and a plurality of fourth computers associated with the plurality of individual lenders defining a plurality of lender computers so that the marketing computer processes a plurality of person-to-person loan requests from the plurality of borrower computers and a plurality of bids for person-to-person loans from the plurality of lender computers responsive to the plurality of person-to-person loan requests, the plurality of borrower computers and the plurality of lender computers each being remote from the bank server;
determining a balance for the account for the benefit of the one or more individual lenders to thereby define a lenders balance so that when communicated to the marketer computer from the bank server the lenders balance limits a bid for a person-to-person loan from the one or more individual lenders responsive to a person-to-person loan request by the one individual borrower, the lenders balance also augments a person-to-person lending profile for the one or more individual lender, the person-to-person lending profile including preferences of the one or more individual lender;
creating a loan from the bank to the one individual borrower responsive to receiving loan terms determined by the marketer computer and responsive to the bid for the person-to-person loan from the one or more individual lenders;
assigning at least part of the loan from the bank to the one or more individual lenders responsive to creating the loan from the one or more individual borrowers to construct the person-to-person loan transaction between the one individual borrower and the one or more individual lenders so that the bank serves as an intermediary for the person-to-person loan transaction; and
withdrawing funds from the account for the benefit of the one or more individual lenders corresponding to the at least part of the loan assigned to the one or more individual lenders.

15. A computer-implemented method as defined in claim 14, wherein the marketer computer publishes aggregate funds available from the plurality of individual lenders for person-to-person lending and wherein the one or more individual lenders is a first individual lender of the plurality of individual lenders; and wherein the computer-implemented method further comprise:
assigning any remaining portion of the loan from the bank to one or more second individual lenders of the plurality of individual lenders responsive to assigning the at least part of the loan from the bank to the first individual lender.

16. A computer-implemented method as defined in claim 14, wherein the funds being available for the person-to-person lending through the marketer computer are being transferred from the one or more individual lenders to the marketer computer and subsequently transferred to the account at the bank for the benefit of one or more individual lenders; and wherein the at least part of the loan is being assigned from the bank to the person-to-person lending marketer and subsequently to the one or more individual lenders so that the person-to-person lending marketer serves as the intermediary for the person-to-person loan transaction.

17. A computer-implemented method as defined in claim 14, wherein the person-to-person lending profile for the one or more individual lenders includes one or more of the following preferences declared by the one or more individual lenders: a preferred interest rate, a preferred group relationship for the one or more individual borrower requesting the loan, a preferred affinity relationship for the one or more individual borrower requesting the loan, a preferred indication of credit worthiness for the one or more individual borrower requesting the loan, and a preferred credit score for the one or more individual borrower.

18. A computer-implemented method as defined in claim 14, wherein the bank is federally-chartered bank subject to federal banking laws and regulations so that state banking laws and regulations are preempted; and wherein the computer-implemented method further comprising:
loading proceeds from the loan onto a prepaid card associated with the one or more individual harrowers.

19. A computer-implemented method as defined in claim 14, wherein the marketer computer publishes aggregate preferences for the plurality of individual lenders to thereby promote funds available for person-to-person lending for one or more borrowers that fit the preferences; and wherein the bank is a first bank and acts as a first intermediary for the person-to-person loan transaction and the computer-implemented method further comprising:
assigning at least a second part of the loan from the first bank to a second bank so that the second bank serves as a second intermediary for the person-to-person loan transaction.

20. A computer program product operable on a first computer associated with a bank to thereby define a bank server and stored in a tangible, non-transitory computer memory media to construct the person-to-person loan transaction between the plurality of individual lenders and one or more of the plurality of individual borrower, the computer program product comprising a set of instructions that, when executed by the bank server, cause the bank server to perform the operations of:
establishing with the bank server an account at the bank for the benefit of one or more individual lenders of a plurality of lenders, the account being identified by an account number so that the bank controls funds associated with the one or more individual lender, the funds being available for person-to-person lending through the bank server, the bank server being adapted to communicate through an electronic communications network with a plurality of third computers associated with a plurality of individual borrowers to thereby define a plurality of borrower computers and a plurality of fourth computers associated with the plurality of individual lenders to thereby define a plurality of lender computers so that the bank server processes a plurality of person-to-person loan requests from the plurality of borrower computers and a plurality of bids for person-to-person loans responsive to the creation of a person-to-person lending profile for the one individual lender by the plurality of lender computers, the plurality of borrower computers and the plurality of lender computers each being remote from the bank server;
determining a balance for the account for the benefit of the one or more individual lenders to thereby define a lenders balance;
generating, without further approval from the one individual lender, a bid for the one or more individual lenders responsive to the person-to-person loan request by the one individual borrower and the creation of the person-to-person lending profile for the one or more individual lender, the bid being limited to the lenders balance;
creating a loan from the bank to the one individual borrower responsive to determining loan terms by the bank server and responsive to the bid for the person-to-person loan;
assigning at least part of the loan from the bank to the one or more individual lenders responsive to creating the loan from the one or more individual borrowers to construct the person-to-person loan transaction between the one or more individual borrowers and the one or more individual lenders so that the bank serves as an intermediary for the person-to-person loan transaction; and withdrawing funds from the account for the benefit of the one or more individual lenders corresponding to the at least part of the loan assigned to the one or more individual lenders.

21. A computer program product as defined claim 21, wherein the one or more individual lenders is a first individual lender of the plurality of individual lenders; and wherein the operations further comprise:
assigning any remaining portion of the loan from the bank to one or more second individual lenders of the plurality of individual lenders responsive to assigning the at least part of the loan from the bank to the first individual lender.

22. A computer program product as defined claim 21, wherein the person-to-person lending profile for the one or more individual lenders includes a maximum bid for one or more person-to-person loans and the lending profile further includes one or more of the following preferences declared by the one or more individual lenders: a preferred interest rate, a preferred group relationship for the one or more individual borrower requesting the loan, a preferred affinity relationship for the one or more individual borrower requesting the loan, a preferred indication of credit worthiness for the one or more individual borrower requesting the loan, and a preferred credit score for the one or more individual borrower.

23. A computer program product as defined claim 21, wherein the bank is federally-chartered bank subject to federal banking laws and regulations so that state banking laws and regulations are preempted; and wherein the operations further comprising:
loading proceeds from the loan onto a prepaid card associated with the one or more individual borrowers.

24. A computer program product as defined claim 21, wherein the bank is a first bank and acts as a first intermediary for the person-to-person loan transaction and the operations further comprising:
assigning at least a second part of the loan from the first bank to a second bank so that the second bank serves as a second intermediary for the person-to-person loan transaction.

25. A computer-implemented method for causing a first computer associated with a bank and having at least a processor and a tangible, non-transitory memory to thereby define a bank server to perform a process of creating a loan from the bank to one or more individual borrowers of a plurality of individual borrowers and a process of assigning at least part of the loan from the bank to one or more individual lenders of a plurality of individual lenders to construct a person-to-person loan transaction between the one or more individual lenders and the one individual borrower, the computer-implemented method comprising:
establishing with the bank server an account at the bank for the benefit of one or more individual lenders of a plurality of lenders, the account being identified by an account number so that the bank controls funds associated with the one or more individual lender, the funds being available for person-to-person lending through the bank server, the bank server being adapted to communicate through an electronic communications network with a plurality of third computers associated with a plurality of individual borrowers to thereby define a plurality of borrower computers and a plurality of fourth computers associated with the plurality of individual lenders to thereby define a plurality of lender computers so that the bank server processes a plurality of person-to-person loan requests from the plurality of borrower computers and a plurality of bids for person-to-person loans responsive to the creation of a person-to-person lending profile for the one individual lender by the one or more lender computers, the plurality of borrower computers and the plurality of lender computers each being remote from the bank server;
determining a balance for the account for the benefit of the one or more individual lenders to thereby define a lenders balance;
generating, without further approval from the one individual lender, a bid for the one or more individual lenders responsive to the person-to-person loan request by the one individual borrower and the creation of the person-to-person lending profile for the one or more individual lender, the bid being limited to the lenders balance;
creating a loan from the bank to the one individual borrower responsive to determining loan terms by the bank server and responsive to the bid for the person-to-person loan;
assigning at least part of the loan from the bank to the one or more individual lenders responsive to creating the loan from the one or more individual borrowers to construct the person-to-person loan transaction between the one or more individual borrowers and the one or more individual lenders so that the bank serves as an intermediary for the person-to-person loan transaction; and
withdrawing funds from the account for the benefit of the one or more individual lenders corresponding to the at least part of the loan assigned to the one or more individual lenders.

26. A computer-implemented method as defined claim 25, wherein the person-to-person lending profile for the one or more individual lenders includes a maximum bid for one or more person-to-person loans and the lending profile further includes one or more of the following preferences declared by the one or more individual lenders: a preferred interest rate, a preferred group relationship for the one or more individual borrower requesting the loan, a preferred affinity relationship for the one or more individual borrower requesting the loan, a preferred indication of credit worthiness for the one or more individual borrower requesting the loan, and a preferred credit score for the one or more individual borrower.

27. A computer-implemented method as defined claim 25, wherein the bank is federally-chartered bank subject to federal banking laws and regulations so that state banking laws and regulations are preempted; and wherein the operations further comprising:
loading proceeds from the loan onto a prepaid card associated with the one or more individual borrowers.

28. A computer-implemented method as defined claim 25, wherein the bank is a first bank and acts as a first intermediary for the person-to-person loan transaction and the computer-implemented method further comprising:
assigning at least a second part of the loan from the first bank to a second bank so that the second bank serves as a second intermediary for the person-to-person loan transaction.
